(19) United States
(12) Patent Application Publication
(10) Pub. No.: US 2020/0234467 A1
(43) Pub. Date: Jul. 23, 2020

(54) CAMERA SELF-CALIBRATION NETWORK

(71) Applicant: NEC Laboratories America, Inc., Princeton, NJ (US)

(72) Inventors: Quoc-Huy Tran, Santa Clara, CA (US); Bingbing Zhuang, Cupertino, CA (US); Pan Ji, San Jose, CA (US); Manmohan Chandraker, Santa Clara, CA (US)

(21) Appl. No.: 16/736,451

(22) Filed: Jan. 7, 2020

Related U.S. Application Data
(60) Provisional application No. 62/793,948, filed on Jan. 18, 2019.
(60) Provisional application No. 62/878,819, filed on Jul. 26, 2019.

(51) Int. Cl. G06T 7/80; G06T 7/64; G06T 5/00; G06N 3/08

(52) U.S. Cl. CPC G06T 7/80; G06T 7/64; G06T 2207/20081; G06N 3/08; G06T 5/006

(57) ABSTRACT

Systems and methods for camera self-calibration are provided. The method includes receiving real uncalibrated images, and estimating, using a camera self-calibration network, multiple predicted camera parameters corresponding to the real uncalibrated images. Deep supervision is implemented based on a dependence order between the plurality of predicted camera parameters to place supervision signals across multiple layers according to the dependence order. The method also includes determining calibrated images using the real uncalibrated images and the predicted camera parameters.

### RELATED APPLICATION INFORMATION

This application claims priority to U.S. Provisional Patent Application No. 62/793,948, filed on Jan. 18, 2019, and U.S. Provisional Patent Application No. 62/878,819, filed on Jul. 26, 2019, incorporated herein by reference in their entirety.

### BACKGROUND

### Technical Field

The present invention relates to deep learning and more particularly to applying deep learning for camera self-calibration.

### Description of the Related Art

Deep learning is a machine learning method based on artificial neural networks. Deep learning architectures can be applied to fields including computer vision, speech recognition, natural language processing, audio recognition, social network filtering, machine translation, bioinformatics, drug design, medical image analysis, material inspection and board game programs, etc. Deep learning can be supervised, semi-supervised or unsupervised.

### SUMMARY

According to an aspect of the present invention, a method is provided for camera self-calibration. The method includes receiving real uncalibrated images, and estimating, using a camera self-calibration network, multiple predicted camera parameters corresponding to the real uncalibrated images. Deep supervision is implemented based on a dependence order between the plurality of predicted camera parameters to place supervision signals across multiple layers according to the dependence order. The method also includes determining calibrated images using the real uncalibrated images and the predicted camera parameters.

According to another aspect of the present invention, a system is provided for camera self-calibration. The system includes a processor device operatively coupled to a memory device, the processor device being configured to receive real uncalibrated images, and estimate, using a camera self-calibration network, multiple predicted camera parameters corresponding to the real uncalibrated images. Deep supervision is implemented based on a dependence order between the plurality of predicted camera parameters to place supervision signals across multiple layers according to the dependence order. The processor device also determines calibrated images using the real uncalibrated images and the predicted camera parameters.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a generalized diagram of a neural network, in accordance with an embodiment of the present invention;

FIG. 2 is a diagram of an artificial neural network (ANN) architecture, in accordance with an embodiment of the present invention;

FIG. 3 is a block diagram illustrating a convolutional neural network (CNN) architecture for estimating camera parameters from a single uncalibrated image, in accordance with an embodiment of the present invention;

FIG. 4 is a block diagram illustrating a detailed architecture of a camera self-calibration network, in accordance with an embodiment of the present invention;

FIG. 5 is a block diagram illustrating a system for application of camera self-calibration to uncalibrated simultaneous localization and mapping (SLAM), in accordance with an embodiment of the present invention;

FIG. 6 is a block diagram illustrating a system for application of camera self-calibration to uncalibrated structure from motion (SFM), in accordance with an embodiment of the present invention;

FIG. 7 is a block diagram illustrating degeneracy in two-view radial distortion self-calibration under forward motion, in accordance with an embodiment of the present invention; and

FIG. 8 is a flow diagram illustrating a method for implementing camera self-calibration, in accordance with an embodiment of the present invention.

### DETAILED DESCRIPTION OF PREFERRED EMBODIMENTS

In accordance with embodiments of the present invention, systems and methods are provided to/for camera self-calibration. The systems and methods implement a convolutional neural network (CNN) architecture for estimating radial distortion parameters as well as camera intrinsic parameters (e.g., focal length, center of projection) from a single uncalibrated image. The systems and methods apply deep supervision for exploiting the dependence between the predicted parameters, which leads to improved regularization and higher accuracy. In addition, applications of the camera self-calibration network can be implemented for simultaneous localization and mapping (SLAM)/structure from motion (SFM) with uncalibrated images/videos.

In one embodiment, during a training phase, a set of calibrated images and corresponding camera parameters are used for generating synthesized camera parameters and synthesized uncalibrated images. The uncalibrated images are then used as input data, while the camera parameters are then used as supervision signals for training the proposed camera self-calibration network. At a testing phase, a single real uncalibrated image is input to the network, which predicts camera parameters corresponding to the input image. Finally, the uncalibrated image and estimated camera parameters are sent to the rectification module to produce the calibrated image.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid-state memory, magnetic tape, a removable computer diskette, a random-access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

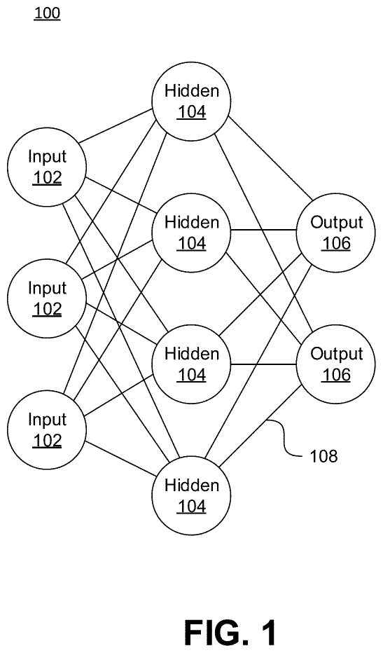

Referring now to the drawings in which like numerals represent the same or similar elements and initially to FIG. 1, a generalized diagram of a neural network is shown, according to an example embodiment.

An artificial neural network (ANN) is an information processing system that is inspired by biological nervous systems, such as the brain. The key element of ANNs is the structure of the information processing system, which includes many highly interconnected processing elements (called “neurons”) working in parallel to solve specific problems. ANNs are furthermore trained in-use, with learning that involves adjustments to weights that exist between the neurons. An ANN is configured for a specific application, such as pattern recognition or data classification, through such a learning process.

ANNs demonstrate an ability to derive meaning from complicated or imprecise data and can be used to extract patterns and detect trends that are too complex to be detected by humans or other computer-based systems. The structure of a neural network generally has input neurons 102 that provide information to one or more “hidden” neurons 104. Connections 108 between the input neurons 102 and hidden neurons 104 are weighted and these weighted inputs are then processed by the hidden neurons 104 according to some function in the hidden neurons 104, with weighted connections 108 between the layers. There can be any number of layers of hidden neurons 104, and as well as neurons that perform different functions. There exist different neural network structures as well, such as convolutional neural network, maxout network, etc. Finally, a set of output neurons 106 accepts and processes weighted input from the last set of hidden neurons 104.

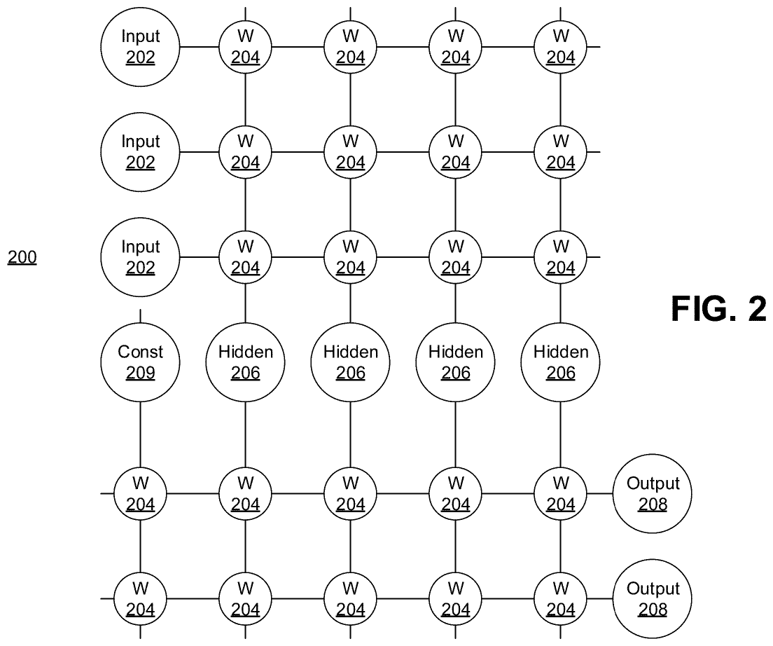

This represents a “feed-forward” computation, where information propagates from the input neurons 102 to the output neurons 106. The training data (or, in some instances, testing data) can include calibrated images, camera parameters and uncalibrated images (for example, stored in a database). The training data can be used for single-image self-calibration as described herein below with respect to FIGS. 2 to 7. For example, the training or testing data can include images or videos that are downloaded from the Internet without access to the original cameras, or camera parameters have been changed due to different causes such as vibrations, thermical/mechanical shocks, or zooming effects. In such cases, camera self-calibration (camera auto-calibration) which computes camera parameters from one or more uncalibrated images is preferred. The example embodiments implement a convolution neural network (CNN)-based approach to camera self-calibration from a single uncalibrated image, e.g., with unknown focal length, center of projection, and radial distortion.

Upon completion of a feed-forward computation, the output is compared to a desired output available from training data. The error relative to the training data is then processed in “feed-back” computation, where the hidden neurons 104 and input neurons 102 receive information regarding the error propagating backward from the output neurons 106. Once the backward error propagation has been completed, weight updates are performed, with the weighted connections 108 being updated to account for the received error. This represents just one variety of ANN.

Referring now to FIG. 2, an artificial neural network (ANN) architecture 200 is shown. It should be understood that the present architecture is purely exemplary and that other architectures or types of neural network may be used instead. The ANN embodiment described herein is included with the intent of illustrating general principles of neural network computation at a high level of generality and should not be construed as limiting in any way.

Furthermore, the layers of neurons described below and the weights connecting them are described in a general manner and can be replaced by any type of neural network layers with any appropriate degree or type of interconnectivity. For example, layers can include convolutional layers, pooling layers, fully connected layers, softmax layers, or any other appropriate type of neural network layer. Furthermore, layers can be added or removed as needed and the weights can be omitted for more complicated forms of interconnection.

During feed-forward operation, a set of input neurons 202 each provide an input signal in parallel to a respective row of weights 204. In the hardware embodiment described herein, the weights 204 each have a respective settable value, such that a weighted output passes from the weight 204 to a respective hidden neuron 206 to represent the weighted input to the hidden neuron 206. In software embodiments, the weights 204 may simply be represented as coefficient values that are multiplied against the relevant signals. The signal from each weight adds column-wise and flows to a hidden neuron 206.

The hidden neurons 206 use the signals from the array of weights 204 to perform some calculation. The hidden neurons 206 then output a signal of their own to another array of weights 204. This array performs in the same way, with a column of weights 204 receiving a signal from their respective hidden neuron 206 to produce a weighted signal output that adds row-wise and is provided to the output neuron 208.

It should be understood that any number of these stages may be implemented, by interposing additional layers of arrays and hidden neurons 206. It should also be noted that some neurons may be constant neurons 209, which provide a constant output to the array. The constant neurons 209 can be present among the input neurons 202 and/or hidden neurons 206 and are only used during feed-forward operation.

During back propagation, the output neurons 208 provide a signal back across the array of weights 204. The output layer compares the generated network response to training data and computes an error. The error signal can be made proportional to the error value. In this example, a row of weights 204 receives a signal from a respective output neuron 208 in parallel and produces an output which adds column-wise to provide an input to hidden neurons 206. The hidden neurons 206 combine the weighted feedback signal with a derivative of its feed-forward calculation and store an error value before outputting a feedback signal to its respective column of weights 204. This back-propagation travels through the entire network 200 until all hidden neurons 206 and the input neurons 202 have stored an error value.

During weight updates, the stored error values are used to update the settable values of the weights 204. In this manner the weights 204 can be trained to adapt the neural network 200 to errors in its processing. It should be noted that the three modes of operation, namely feed forward, back propagation, and weight update, do not overlap with one another.

A convolutional neural network (CNN) is a subclass of ANNs which has at least one convolution layer. A CNN consists of an input and an output layer, as well as multiple hidden layers. The hidden layers of a CNN consist of convolutional layers, rectified linear unit (RELU) layers (e.g., activation functions), pooling layers, fully connected layers and normalization layers. Convolutional layers apply a convolution operation to the input and pass the result to the next layer. The convolution emulates the response of an individual neuron to visual stimuli.

CNNs can be applied to analyzing visual imagery. CNNs can capture local information (e.g., neighbor pixels in an image or surrounding words in a text) as well as reduce the complexity of a model (to allow, for example, faster training, requirement of fewer samples, and reduction of the chance of overfitting).

CNNs use a variation of multilayer perceptrons designed to require minimal preprocessing. CNNs are also known as shift invariant or space invariant artificial neural networks (SIANN), based on their shared-weight architectures and translation invariance characteristics. CNNs can be used for applications in image and video recognition, recommender systems, image classification, medical image analysis, and natural language processing.

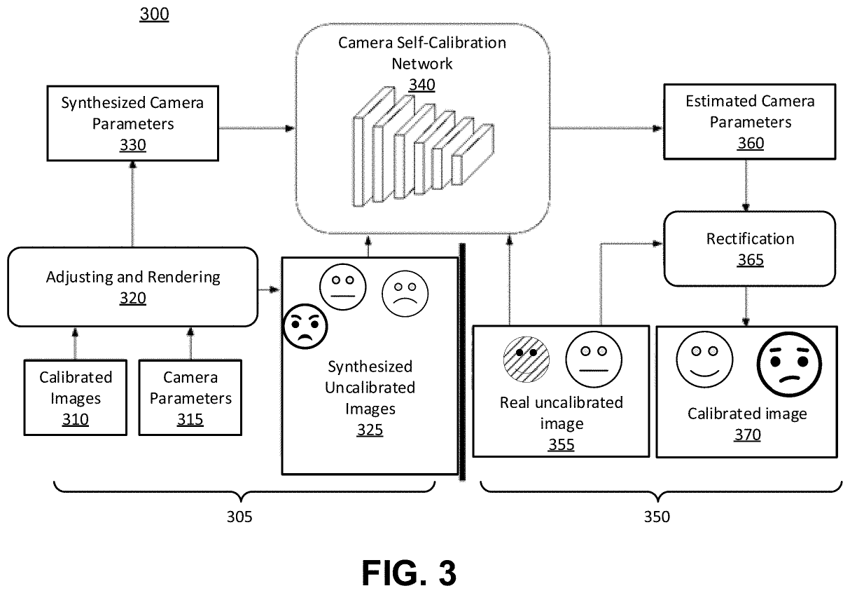

The CNNs can be incorporated into a CNN architecture for estimating camera parameters from a single uncalibrated image, such as described herein below with respect to FIGS. 3 to 7. For example, the CNNs can be implemented to produce images that are then used as input for SFM/SLAM systems.

Referring now to FIG. 3, a block diagram illustrating a CNN architecture for estimating camera parameters from a single uncalibrated image, in accordance with example embodiments.

As shown in FIG. 3, architecture 300 includes a CNN architecture for estimating radial distortion parameters as well as (alternatively, in addition to, etc.) camera intrinsic parameters (for example, focal length, center of projection) from a single uncalibrated image. Architecture 300 can be implemented to apply deep supervision that exploits the dependence between the predicted parameters, which leads to improved regularization and higher accuracy. In addition, architecture 300 can implement application of a camera self-calibration network towards Structure from Motion (SFM) and Simultaneous Localization and Mapping (SLAM) with uncalibrated images/videos.

Computer vision processes such as SFM and SLAM assume a pin-hole camera model (which describes a mathematical relationship between points in three-dimensional coordinates and points in image coordinates in an ideal pin-hole camera) and require input images or videos taken with known camera parameters, including focal length, principal point, and radial distortion. Camera calibration is the process of estimating camera parameters. Architecture 300 can implement camera calibration in instances in which a calibration object (for example, checkerboard) or a special scene structure (for example, compass direction from a single image by Bayesian Inference) is not available before the camera is deployed in computer vision applications. For example, architecture 300 can be implemented for the cases where images or videos are downloaded from the Internet without access to the original cameras, or camera parameters have been changed due to different causes such as vibrations, thermical/mechanical shocks, or zooming effects. In such cases, camera self-calibration (camera auto-calibration) which computes camera parameters from one or more uncalibrated images is preferred. The present invention proposes a convolution neural network (CNN)-based approach to camera self-calibration from a single uncalibrated image, e.g., with unknown focal length, center of projection, and radial distortion. In addition, architecture 300 can be implemented in applications directed towards uncalibrated SFM and uncalibrated SLAM.

The systems and methods described herein employ deep supervision for exploiting the relationship between different tasks and achieving superior performance. In contrast to processes for single-image self-calibration, the systems and methods described herein make use of all features available in the image and do not make any assumption on scene structures. The results are not dependent on first extracting line/curve features in the input image and then relying on them for estimating camera parameters. The systems and methods are not dependent on detecting line/curve features properly, nor on satisfying any underlying assumption on scene structures.

Architecture 300 can be implemented to process uncalibrated images/videos without assuming input images/videos with known camera parameters (in contrast to some SFM/SLAM systems). Architecture 300 can apply processing, for example in challenging cases such as in the presence of significant radial distortion, in a two-step approach that first performs camera self-calibration (including radial distortion correction) and then employs reconstruction processes, such as SFM/SLAM systems on the calibrated images/videos.

As shown in FIG. 3, architecture 300 implements a CNN-based approach to camera self-calibration. During the training phase 305, a set of calibrated images 310 and corresponding camera parameters 315 are used for generating synthesized camera parameters 330 and synthesized uncalibrated images 325. The uncalibrated images 325 are then used as input data (for the camera self-calibration network 340), while the camera parameters 330 are then used as supervision signals for training the camera self-calibration network 340. At testing phase 350, a single real uncalibrated image 355 is input to the camera self-calibration network 340, which predicts (estimated) camera parameters 360 corresponding to the input image 355. The uncalibrated image 355 and estimated camera parameters 360 are sent to the rectification module 365 to produce the calibrated image 370.

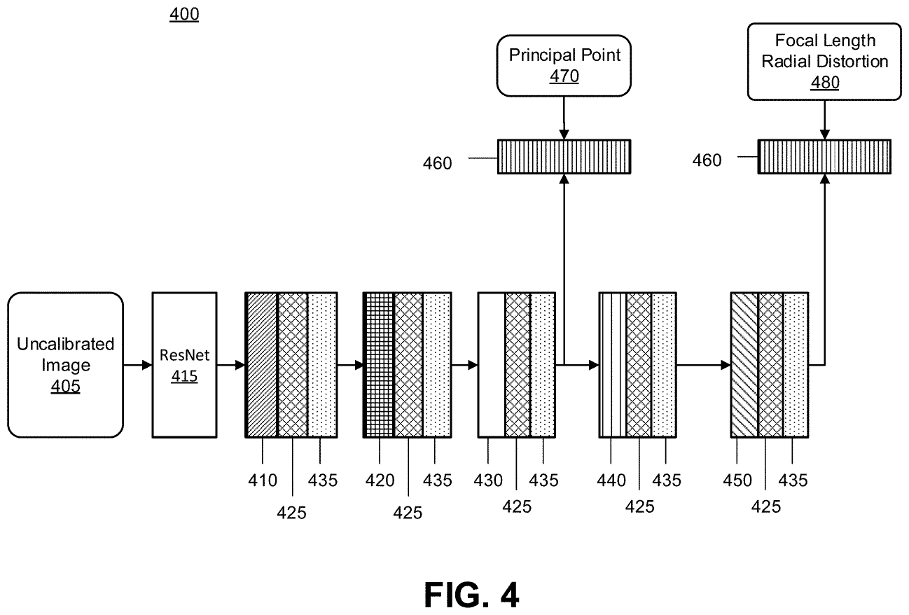

FIG. 4 is a block diagram illustrating a detailed architecture 400 of a camera self-calibration network 340, in accordance with example embodiments.

As shown in FIG. 4, architecture 400 (for example, of camera self-calibration network 340) receives an uncalibrated image 405 (such as synthesized uncalibrated images 325 during training 305, or real uncalibrated image 355 during testing 350). For example, architecture 400 performs deep supervision during network training. In contrast to conventional multi-task supervision, which predicts all the parameters (places all the supervisions) at the last layer only, deep supervision exploits the dependence order between the predicted parameters and predicts the parameters (places the supervisions) across multiple layers according to that dependence order. For camera self-calibration, knowing that: (1) a known principal point is clearly a prerequisite for estimating radial distortion, and (2) image appearance is affected by the composite effect of radial distortion and focal length, the system can predict the parameters (place the supervisions) in the following order: (1) principal point in the first branch and (2) both focal length and radial distortion in the second branch. Therefore, according to example embodiments, architecture 400 uses a residual network (for example, ResNet-34) 415 as a base model and adds (for example, some, a few, etc.) convolutional layers (for example, layers 410 (Cony, 512, 3×3), 420 (Cony, 256, 3×3), 430 (Cony, 128, 3×3), 440 (Cony, 64, 3×3), 450 (Cony, 32, 3×3) and 460 (Cony, 2, 1×1), batch normalization layers 425, and ReLU activation layers 435 for tasks of principal point estimation 470 (for example, cx, cy), focal length (f) estimation, and radial distortion (λ) estimation 480. Architecture 400 can use (for example, employ, implement, etc.) deep supervision for exploiting the dependence between the tasks. For example, in an example embodiment, principal point estimation 470 is an intermediate task for radial distortion estimation and focal length estimation 480, which leads to improved regularization and higher accuracy.

Deep supervision exploits the dependence order between the plurality of predicted camera parameters and predicts the camera parameters (places the supervision signals) across multiple layers according to that dependence order. Deep supervision can be implemented based on principal point estimation as an intermediate task for radial distortion estimation and focal length estimation, because: (1) a known principal point is clearly a prerequisite for estimating radial distortion, and (2) image appearance is affected by the composite effect of radial distortion and focal length.

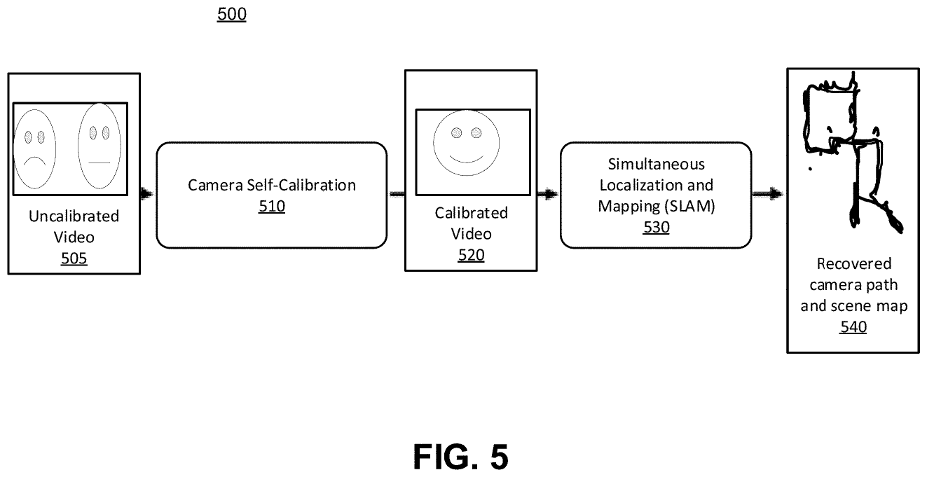

FIG. 5 is a block diagram illustrating a system 500 for application of camera self-calibration to uncalibrated SLAM, in accordance with example embodiments.

As shown in FIG. 5, camera self-calibration can be applied to uncalibrated

SLAM. An input video is a set of consecutive image frames that are uncalibrated (uncalibrated video 505). Each frame is then passed respectively to the camera self-calibration (component) 510, for example the system 300 in FIG. 3, which produces the corresponding calibrated frame (and correspondingly, calibrated video 520). The calibrated frames (calibrated video 520) are then sent to a SLAM module 530 for estimating the camera trajectory and scene structures observed in the video. The system 500 outputs a recovered camera path and scene map 540.

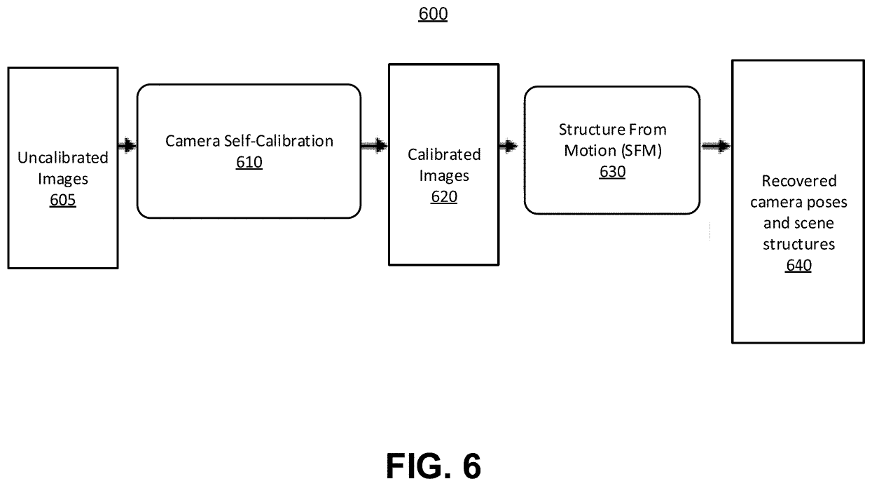

FIG. 6 is a block diagram illustrating a system 600 for application of camera self-calibration to uncalibrated SFM, in accordance with example embodiments.

As shown in FIG. 6, camera self-calibration can be applied to uncalibrated SFM. System 600 can be implemented as a module in a camera or image/video processing device. An unordered set of uncalibrated images such as those obtained from an Internet image search can be used as input (uncalibrated images 605). Each uncalibrated image 605 is then passed separately to the camera self-calibration (component) 610, for example the system 300 in FIG. 3, which produces the corresponding calibrated image 620. The calibrated images 620 are then sent to an SFM module 630 for estimating the camera poses and scene structures observed in the images. System 600 may then output recovered camera poses and scene structures 640.

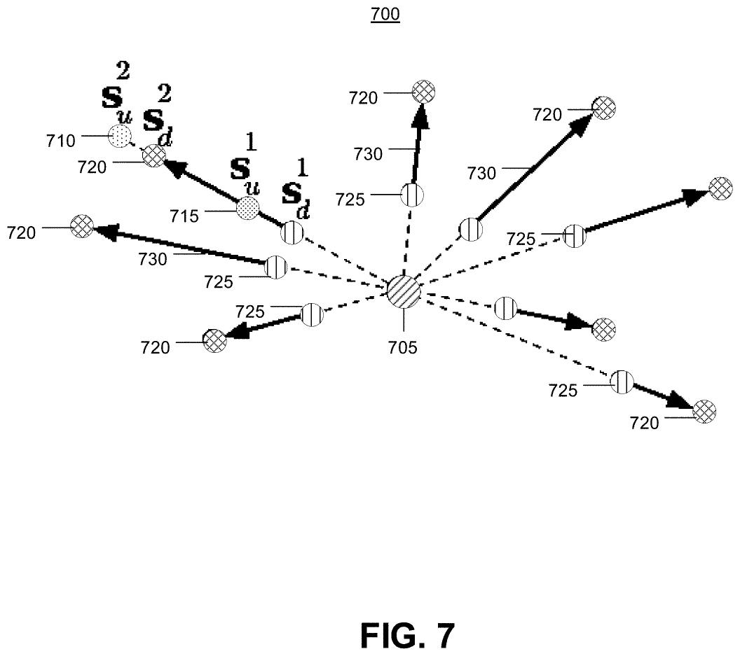

FIG. 7 is a block diagram 700 illustrating degeneracy in two-view radial distortion self-calibration under forward motion, in accordance with the present invention. As shown in FIG. 7, the example embodiments can be applied to degeneracy in two-view radial distortion self-calibration under forward motion. There are infinite number of valid combinations of radial distortion and scene structure, including the special case with zero radial distortion.

Denote the 2D coordinates of a distorted point (720, 725) on a normalized image plane as s_{d}=[x_{d},y_{d}]^{T} and the corresponding undistorted point (710, 715) as sᵤ=[xᵤ,yᵤ]^{T}=f(s_{d};θ)s_{d},θ is the radial distortion parameters and f(s_{d};θ) is the undistortion function which scales s_{d} to sᵤ. The specific form of f(s_{d}; θ) depends on the radial distortion model being used. For instance, the system can have f(s_{d}; λ)=1/(1+1λr²) for the division model with one parameter, or we have f(s_{d}; λ)=1+λr² for the polynomial model with one parameter. In both models, λ is the 1D radial distortion parameter and r=\sqrt{x_{d}²+y_{d}²} is the distance from the principal point 705. The example embodiments can use the general form f(s_{d}; θ) for the analysis below.

The example embodiments formulate the two-view geometric relationship under forward motion, for example, how a pure translational camera motion along the optical axis is related to the 2D correspondences and their depths. In the instance of a 3D point S, expressed as S₁=[X₁,Y₁,Z₁]^{T} and S₂=[X₂,Y₂,Z₂]^{T}, respectively, in the two camera coordinates. Under forward motion, the system can determine that S₂=S₁−T with T=[0,0,t_{z}]^{T}. Without loss of generality, the system fixes t_{z}=1 to remove the global scale ambiguity. Projecting the above relationship onto the image planes, the system obtains

$${s}_{u}^{2} = \frac{{Z}_{1}}{{Z}_{1} - 1} {s}_{u}^{1} ,$$

where sᵤ¹ and sᵤ² are the 2D projections of S₁ and S₂, respectively (for example, {sᵤ¹,sᵤ²} is a 2D correspondence). Expressing the above in terms of the observed distorted points s_{d}¹ and s_{d}² yields:

$$f ( {s}_{d}^{2} ; {θ}_{2} ) {s}_{d}^{2} = \frac{{Z}_{1}}{{Z}_{1} - 1} f ( {s}_{d}^{1} ; {θ}_{1} ) {s}_{d}^{1} \qquad Eq . ( 1 )$$

where θ₁ and θ₂ represent radial distortion parameters in the two images respectively (note that θ₁ may differ from θ₂). Eq. 1 represents all the information available for estimating the radial distortion and the scene structure. However, the correct radial distortion and point depth cannot be determined from the above equation. The system can replace the ground truth radial distortion denoted by {θ₁,θ₂} with a fake radial distortion {θ′₁,θ′₂} and the ground truth point depth Z₁ for each 2D correspondence with the following fake depth Z′₁ such that Eq. 1 still holds:

$${Z}_{1}^{′} = \frac{α {Z}_{1}}{( α - 1 ) {Z}_{1} + 1} , \\ α = \frac{f ( {s}_{d}^{2} ; {θ}_{2}^{′} ) f ( {s}_{d}^{1} ; {θ}_{1} )}{f ( {s}_{d}^{1} ; {θ}_{1}^{′} ) f ( {s}_{d}^{2} ; {θ}_{2} )} \qquad Eq . ( 2 )$$

In particular, the system can set ∀s_{d}¹:f(s_{d}¹;θ′₁=1, ∀s_{d}²:f(s_{d}²;θ′₂=1 as the fake radial distortion, and use the corrupted depth Z′₁ computed according to Eq. 2 so that Eq. 1 still holds. This special solution corresponds to the pinhole camera model, for example, sᵤ¹=s_{d}¹ and sᵤ²=s_{d}². In fact, this special case can be inferred more intuitively. Eq. 1 indicates that all 2D points move along 2D lines radiating from the principal point 705, as illustrated in FIG. 7. This pattern is exactly the same as in the pinhole camera model and is the sole cue to recognize the forward motion.

Intuitively, the 2D point movements induced by radial distortion alone, e.g., between sᵤ¹ and s_{d}¹, or between sᵤ² and s_{d}², are along the same direction as the 2D point movements induced by forward motion alone, e.g., between sᵤ¹ and sᵤ² (see FIG. 7). Hence, radial distortion only affects the magnitudes of 2D point displacements but not their directions in cases of forward motion. Furthermore, such radial distortion can be compensated with an appropriate corruption in the depths so that a corrupted scene structure that explains the image observations, for example, 2D correspondences, exactly in terms of reprojection errors can still be recovered.

Accordingly, the system determines that two-view radial distortion self-calibration is degenerate for the case of pure forward motion. In particular, there are infinite number of valid combinations of radial distortion and scene structure, including the special case of zero radial distortion.

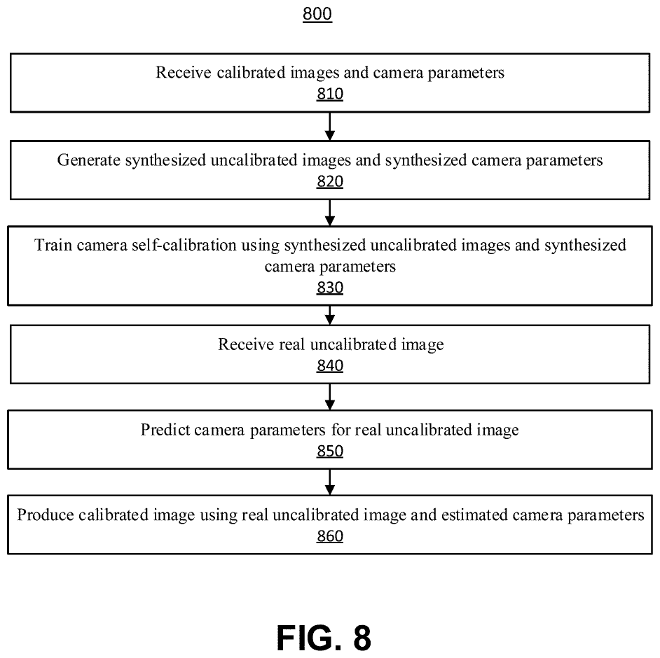

FIG. 8 is a flow diagram illustrating a method 800 for implementing camera self-calibration, in accordance with the present invention.

At block 810, system 300 receives calibrated images and camera parameters. For example, during the training phase, system 300 can accept a set of calibrated images and corresponding camera parameters to be used for generating synthesized camera parameters and synthesized uncalibrated images. The camera parameters can include focal length, center of projection, and radial distortion, etc.

At block 820, system 300 generates synthesized uncalibrated images and synthesized camera parameters.

At block 830, system 300 trains the camera self-calibration network using the synthesized uncalibrated images and synthesized camera parameters. The uncalibrated images are used as input data, while the camera parameters are used as supervision signals for training the camera self-calibration network 340.

At block 840, system 300 receives real uncalibrated images.

At block 850, system 300 predicts (for example, estimates) camera parameters for the real uncalibrated image. System 300 predicts the camera parameters using the camera self-calibration network 340. System 300 can implement deep supervision based on principal point estimation as an intermediate task for radial distortion estimation and focal length estimation. The learned features for estimating principal point are used for estimating radial distortion, and image appearance is determined based on a composite effect of radial distortion and focal length.

At block 860, system 300 produces a calibrated image using the real uncalibrated image and estimated camera parameters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for camera self-calibration, comprising:
receiving at least one real uncalibrated image;
estimating, using a camera self-calibration network, a plurality of predicted camera parameters corresponding to the at least one real uncalibrated image;
implementing deep supervision based on a dependence order between the plurality of predicted camera parameters to place supervision signals across multiple layers according to the dependence order; and
determining at least one calibrated image using the at least one real uncalibrated image and at least one of the plurality of predicted camera parameters.

2. The method as recited in claim 1, further comprising:
receiving, during a training phase, at least one training calibrated image and at least one training camera parameter corresponding to the at least one training calibrated image; and
generating, using the at least one training calibrated image and the at least one training camera parameter, at least one synthesized camera parameter and at least one synthesized uncalibrated image corresponding to the at least one synthesized camera parameter.

3. The method as recited in claim 2, further comprising:
training the camera self-calibration network using the at least one synthesized uncalibrated image as input data and the at least one synthesized camera parameter as a supervision signal.

4. The method as recited in claim 1, wherein estimating the at least one predicted camera parameter further comprises:
performing at least one of principal point estimation, focal length estimation, and radial distortion estimation.

5. The method as recited in claim 1, wherein implementing deep supervision further comprises:
implementing deep supervision based on principal point estimation as an intermediate task for radial distortion estimation and focal length estimation, wherein learned features for estimating principal point are used for estimating radial distortion, and image appearance is determined based on a composite effect of radial distortion and focal length.

6. The method as recited in claim 1, further comprising:
determining a calibrated video based on the at least one calibrated image; and
estimating a camera trajectory and scene structure observed in the calibrated video based on simultaneous localization and mapping (SLAM).

7. The method as recited in claim 1, further comprising:
estimating at least one camera pose and scene structure using structure from motion (SFM) based on the at least one calibrated image.

8. The method as recited in claim 1, wherein determining the at least one calibrated image using the at least one real uncalibrated image and the at least one predicted camera parameter further comprises:
processing the at least one real uncalibrated image and the at least one predicted camera parameter via a rectification process to determine the at least one calibrated image.

9. The method as recited in claim 1, further comprising:
implementing the camera self-calibration network using a residual network as a base and adding at least one convolutional layer, and at least one batch normalization layer.

10. A computer system for camera self-calibration, comprising:
a processor device operatively coupled to a memory device, the processor device being configured to:
receive at least one real uncalibrated image;
estimate, using a camera self-calibration network, a plurality of predicted camera parameters corresponding to the at least one real uncalibrated image;
implement deep supervision based on a dependence order between the plurality of predicted camera parameters to place supervision signals across multiple layers according to the dependence order; and
determine at least one calibrated image using the at least one real uncalibrated image and the at least one predicted camera parameter.

11. The system as recited in claim 10, wherein the processor device is further configured to:
receive, during a training phase, at least one training calibrated image and at least one training camera parameter corresponding to the at least one training calibrated image; and
generate, using the at least one training calibrated image and the at least one training camera parameter, at least one synthesized camera parameter and at least one synthesized uncalibrated image corresponding to the at least one synthesized camera parameter.

12. The system as recited in claim 11, the processor device is further configured to:
train the camera self-calibration network using the at least one synthesized uncalibrated image as input data and the at least one synthesized camera parameter as a supervision signal.

13. The system as recited in claim 10, wherein, when estimating the at least one predicted camera parameter, the processor device is further configured to:
perform at least one of principal point estimation, focal length estimation, and radial distortion estimation.

14. The system as recited in claim 10, wherein, when implementing deep supervision, the processor device is further configured to:
implement deep supervision based on principal point estimation as an intermediate task for radial distortion estimation and focal length estimation, wherein learned features for estimating principal point are used for estimating radial distortion, and image appearance is determined based on a composite effect of radial distortion and focal length.

15. The system as recited in claim 10, wherein the processor device is further configured to:
determine a calibrated video based on the at least one calibrated image; and
estimate a camera trajectory and scene structure observed in the calibrated video based on simultaneous localization and mapping (SLAM).

16. The system as recited in claim 10, wherein the processor device is further configured to:
estimate at least one camera pose and scene structure using structure from motion (SFM) based on the at least one calibrated image.

17. The system as recited in claim 10, wherein, when determining the at least one calibrated image using the at least one real uncalibrated image and the at least one predicted camera parameter, wherein the processor device is further configured to:
process the at least one real uncalibrated image and the at least one predicted camera parameter via a rectification process to determine the at least one calibrated image.

18. The system as recited in claim 10, wherein the processor device is further configured to:
implement the camera self-calibration network using a residual network as a base and adding at least one convolutional layer, and at least one batch normalization layer.

19. A computer program product for camera self-calibration, the computer program product comprising a non-transitory computer readable storage medium having program instructions embodied therewith, the program instructions executable by a computing device to cause the computing device to perform the method comprising:
receiving at least one real uncalibrated image;
estimating, using a camera self-calibration network, at least one predicted camera parameter corresponding to the at least one real uncalibrated image; and
determining at least one calibrated image using the at least one real uncalibrated image and the at least one predicted camera parameter.

20. The computer program product for camera self-calibration of claim 19, wherein the program instructions executable by a computing device further comprise:
receiving, during a training phase, at least one training calibrated image and at least one training camera parameter corresponding to the at least one training calibrated image; and
generating, using the at least one training calibrated image and the at least one training camera parameter, at least one synthesized camera parameter and at least one synthesized uncalibrated image corresponding to the at least one synthesized camera parameter.
